(19) United States
(12) Patent Application Publication
(10) Pub. No.: US 2004/0096031 A1
(43) Pub. Date: May 20, 2004

(54) Medical imaging device

(76) Inventors: Mario Raimondo Caria, Chamalieres (FR); Kenway Montgomery Smith, Glasgow (GB)

Correspondence Address: PIPER RUDNICK, P. O. BOX 64807, CHICAGO, IL, 60664-0807, US

(21) Appl. No.: 10/467,687

(22) PCT Filed: Feb. 8, 2002
(86) PCT No.: PCT/GB02/00549

(30) Foreign Application Priority Data
Feb. 8, 2001 (GB) 0103133.5

(51) Int. Cl. G01N 23/04

(52) U.S. Cl. 378/62

(57) ABSTRACT

A medical imaging device and apparatus (4) having an x-ray detector (10) formed of a plurality of semiconductor pixel detectors (12), each having an associated electric circuit (15) and counter (68, FIG. 5B). In use, a subject disposed between an x-ray generator (2, FIG. 1) and the x-ray detector (10), and is irradiated and the x-rays incident upon the pixel detectors (12) are directly converted into a corresponding electrical signal which is digitised by the electric circuit (15) and counted by the counter (68). These digitised electrical signals represent the energy and incidence position of the absorbed x-rays and can be manipulated to provide an image representative of the x-rayed subject. The image may be such that visual analysis may be performed in real time.

### FIELD OF INVENTION

The present invention relates to a medical imaging device and related system and method, and in particular, though not exclusively to an imaging system for digital angiography.

### BACKGROUND TO INVENTION

In medical radiography traditional x-ray imaging systems have contained conventional film plates on which the image of the subject being irradiated is provided. More recently digital imaging systems have been used for digital radiology. Some current systems use semiconductors with transistor pixels which collect the electrical charge generated by the radiation entering the semiconductor after traversing a conversion plate. The conversion plate is typically a scintillating material which multiplies and converts the x-rays into suitable wavelengths for detection by the transistor pixels. The material which absorbs the radiation after the scintillating plate is usually amorphous silicon. Other known direct detection systems use amorphous selenium to absorb the radiation. A drawback of these systems is that they require a recovery time between each dose of radiation.

Furthermore for use in angiography these systems often rely on a technique known as Digital Subtraction Angiography wherein a first irradiation image is taken prior to the injecting of a contrast fluid. The contrast fluid, usually iodine-based, is then injected into the relevant area and a second irradiation image is taken. The first image is then subtracted from the second image providing an enhanced contrast in the final display. However, this technique necessarily requires at least two doses of irradiation and furthermore, some patients may have an allergy to the contrast fluids such as iodine.

An object of at least one aspect of the present invention is to obviate or mitigate at least one of the aforementioned problems by using direct detection photon counting pixel detectors.

### SUMMARY OF INVENTION

According to a first aspect of the present invention there is provided:

medical imaging device comprising an x-ray detector having:

a plurality of semiconductor pixel detectors wherein, in use, x-rays incident upon a semiconductor pixel detector are directly converted into a corresponding electrical signal.

Preferably the electrical signal from each pixel detector may be fed to at least one electric circuit whereupon the signal is digitised.

Preferably the number of x-rays, within a selected energy range, absorbed by each pixel detector is recorded by a binary counter or scaler counter embedded in each pixel.

Preferably the detector arrangement is effective for detecting x-rays having an energy above 1 keV, likely in the range of 1 to 200 keV, and in one embodiment above 50 keV.

Preferably the electrical signals represent the energy and position of the absorbed x-rays.

Preferably the semiconductor pixel detectors comprise a plurality of semiconductor wafer chips, each preferably disposed on an electric circuit chip tiled together.

Preferably each semiconductor wafer chip contains a plurality of pixels.

Preferably each pixel detector is an x-ray photon counter wherein each pixel detector element generates a charge pulse corresponding to an energy of an absorbed incident photon and preferably also counts the number of absorbed photons.

Preferably an electrical contact is made on a back side of the semiconductor wafer and a rectifying contact is made by an electrode embedded in each semiconductor pixel.

Preferably each pixel electrode is connected to a corresponding electric signal digitising circuit.

Preferably the electric circuit is formed of a plurality of pixel signal digitising circuits each corresponding to a pixel of the semiconductor wafer.

Preferably each electric circuit is a single Read Out Integrated Circuit (ROIC).

Preferably the semiconductor pixel detectors are made from a compound semiconductor material, eg a group III-V semiconductor material.

In one embodiment the semiconductor comprises a Gallium Arsenide based materials system.

In such an embodiment the semiconductor may be formed from epitaxially formed Gallium Arsenide, or alloys thereof formed on a Gallium Arsenide substrate.

Alternatively the semiconductor may be formed from Silicon or Cadmium Telluride or alloys thereof.

Preferably enhanced image quality is obtained by incorporating pulse height analysis on the electric signal processing of each pixel of the ROIC to permit counting, via energy selection, of only the most appropriate energies of the absorbed x-rays for optimising image quality.

The x-ray detector of the medical imaging device may alternatively comprise a plurality of monolithic semiconductor pixel detectors wherein x-rays incident upon the monolithic semiconductor pixels are directly converted into a corresponding electrical signal. Preferably the electrical signal is digitised and processed in electronics embedded within the monolithic semiconductor pixel detector.

Alternatively the x-ray detector of the medical imaging device may comprise a semiconductor substrate on one surface of which is disposed a plurality of electrodes formed of strips, and on an opposing surface of which is disposed a plurality of reverse biased p-n junction electrodes formed as strips and running perpendicularly to those formed on the top of the substrate, wherein each x-ray photon incident upon the detector creates an electrical signal at an intersection point of the electrodes on the opposing surfaces representative of the position thereof, and preferably the energy of the photon.

According to a second aspect of the present invention, there is provided a medical imaging apparatus including a medical imaging device, the device comprising a plurality of semiconductor pixel detectors operably connected to at least one electrical circuit, wherein in use x-rays incident upon the detectors are converted to a corresponding electrical signal.

Preferably an x-ray generator generates the x-rays incident upon the detector.

Preferably the imaging apparatus is arranged so that a subject can be disposed between the x-ray generator and the semiconductor pixel detectors, and wherein the electrical signal generated by the x-rays is representative of a subject which has been irradiated.

Preferably the generated x-rays have a radiation energy in the range of 1 keV to 200 keV.

Preferably the radiation energy has more than one value in the range of 1 keV to 200 keV.

The medical imaging device semiconductor pixel detectors may comprise a plurality of semiconductor wafer chips tiled together.

Preferably each semiconductor wafer contains a plurality of pixels.

Preferably each pixel is a photon counter wherein each pixel detector element counts the number of incident photons and measures the corresponding energy thereof.

According to a third aspect of the present invention there is provided a method of x-ray imaging a subject comprising the steps of:

disposing the required body part between an x-ray generator and detector;

irradiating the body part with x-rays generated by the x-ray generator; and

directly converting the x-rays received by the detector to an electrical charge, the conversion being performed by semiconductor pixels within the detector.

Preferably the method includes the additional steps of transferring the electric charge, created by the absorbed x-ray energy, to an electrode embedded in the respective pixel of a Read-out Integrated Circuit (ROIC), by means of an electric field and converting the electric charge into an electrical signal.

Preferably the method may include the additional steps of:

collecting the electrical charge from the pixels;

digitising the electric charge;

storing the digitised electric charge as data in a buffer within the ROIC pixel;

manipulating the stored data to provide an image representative of the x-rayed subject.

Preferably the method also includes collecting the electrical signal at each electrode in a row of pixels, and transferring the electrical signal via the electric circuit to a read out cell at the end of the row.

Preferably the method includes collecting the pixel data from the read out cell of each row simultaneously and transferring the collected data to a buffer.

Preferably the method also includes transferring the digitised signals from the system to video and recording systems for visual analysis.

Preferably the method includes performing visual analysis in real time.

Preferably the method includes generating images in real time wherein the interval between images is less than one second.

Preferably the method includes generating images having a resolution of at least 3 line pairs per mm.

Preferably the method includes exposing the subject to only one irradiation in order to obtain an image of the subject.

In one implementation the method may include using a contrast fluid when irradiating the subject, possibly introducing the contrast fluid to the subject by injection into peripheral arteries.

In an alternative and preferred implementation, no use of contrast fluid is necessary.

According to a fourth aspect of the present invention, there is provided use of a medical imaging device x-ray imaging of a subject, the device comprising a plurality of semiconductor pixel detectors and at least one electrical circuit whereupon a flux of x-rays which have irradiated the subject are incident upon the semiconductor pixels and are converted into corresponding electrical signals.

Preferably the flux of x-rays do not exceed a predetermined rate, eg., 1 MHZ.

Preferably the electrical signals are indicative of the number and energy of individual respective photons.

Preferably the electrical signals are fed to at least one electric circuit, whereupon the signals are digitised.

Preferably an image of the subject is reconstructed by at least one of the electric circuits from the electrical signals.

Preferably only one irradiation of the subject is required in order to obtain an image of the subject.

Preferably the subject may be a body part of a patient.

An advantage of at least one embodiment of the present invention is that a dose of x-ray radiation of at least 50 % less than that used in known systems is required to obtain a clear image of the subject.

An advantage of at least one embodiment of the present invention is that the dose of contrast fluid within a carrier fluid may be at least a factor of 10 less than that used when irradiating using known systems.

Preferably the medical imaging system is adapted for use in performing angiography, preferably for humans, though alternatively animals.

Alternatively the medical imaging system is adapted for use in imaging and diagnosis in vivo blood vessels and conduits, e.g. in humans or animals.

The aforementioned devices, apparatus and methods may be particularly suitable and adapted for use in angiography.

### BRIEF DESCRIPTION OF DRAWINGS

These and other aspects of the invention will become apparent from the following description taken in combination with the drawings in which;

FIG. 1 shows a medical imaging system according to an embodiment of the present invention.

FIG. 2 shows an x-ray detector partly cut away according to an embodiment of the present invention.

FIG. 3A shows a schematic representation of a detector chip and readout chip arrangement according to an embodiment of the present invention.

FIG. 3B shows a schematic view of the x-ray detector according to an embodiment of the present invention.

FIG. 4 shows a schematic cross sectional view of a single pixel detector of the x-ray detector of FIG. 2.

FIG. 5A shows a schematic representation of a read out circuit arrangement of a pixel array according to an embodiment of the present invention.

FIG. 5B shows a circuit diagram of pixel detector electronics according an embodiment of the present invention.

FIG. 6 shows a schematic view of an energy selection process of the present invention.

FIGS. 7(a) and 7(b) show images achieved at different energy selection levels according to the present invention.

FIG. 8(a) shows an image obtained using the imaging device of the present invention.

FIG. 8(b) shows an image obtained using a known medical imaging system.

FIG. 9 shows a schematic cross sectional view of a pixel detector according to another embodiment of the invention.

FIG. 10 shows a cross sectional view of a crossed microstrip detector according to a yet other embodiment of the invention.

### DETAILED DESCRIPTION OF DRAWINGS

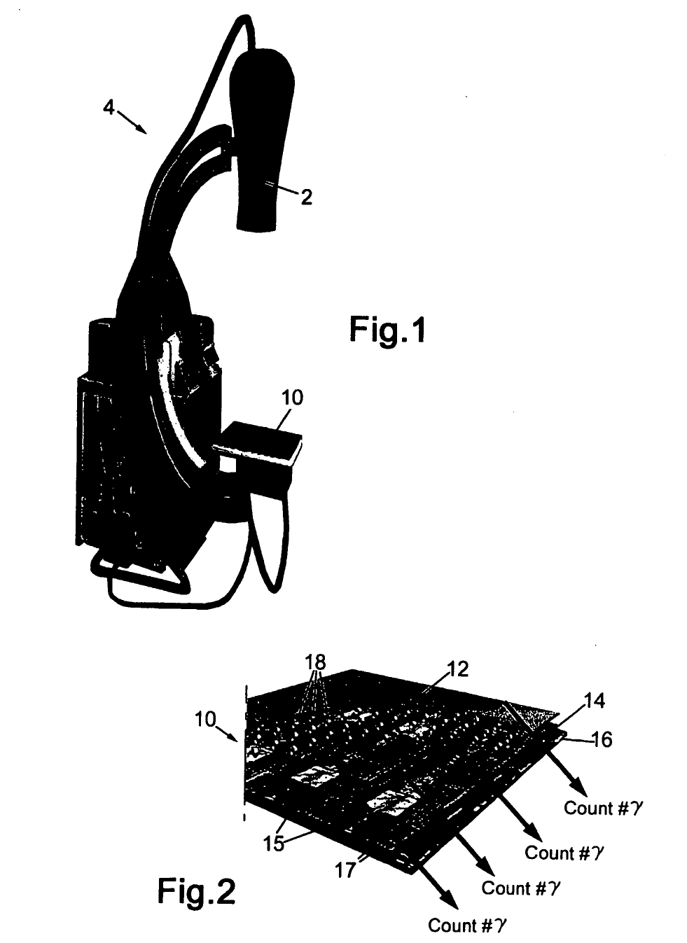

FIG. 1 shows a medical imaging system, generally designated 4, provided with x-ray detector plate 10 and x-ray generator 2 which generates x-rays with a plurality of radiation values ranging from 1 keV to 200 keV. A subject or body part which is to be irradiated is placed in space between generator 2 and detector 10.

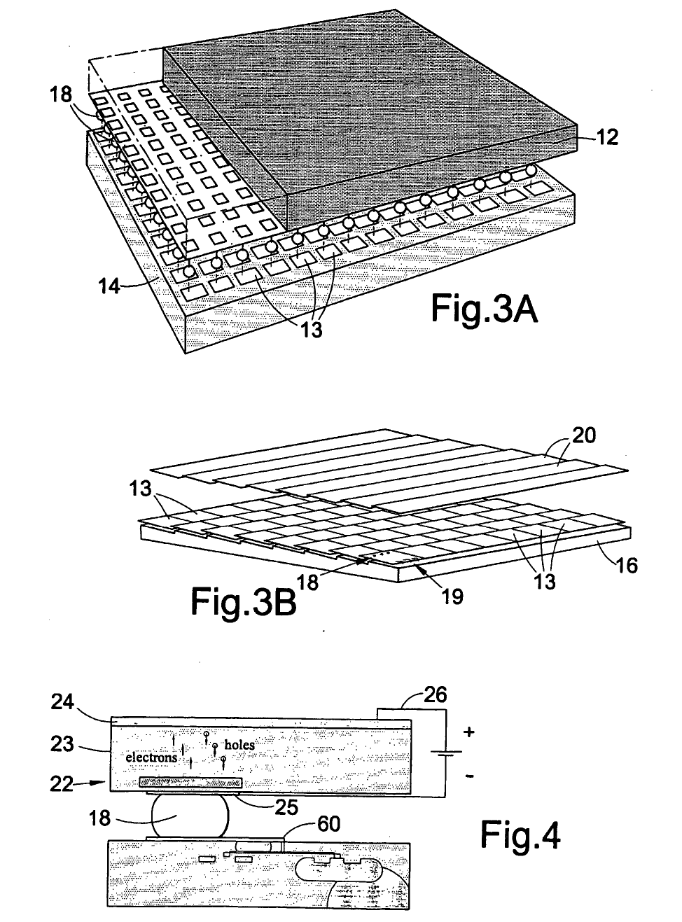

With reference to FIG. 2, an x-ray detector plate 10 is shown. Detector plate 10 comprises a layer of semiconductor pixel detectors 12, connected via a layer of solder bumps 18 to matching layer 14 formed of a plurality of pixel Read Out Integrated Circuits (ROIC) 15 connected by control tracks 17 to control and data acquisition circuit 16. A schematic representation is shown in FIG. 3A of semiconductor pixel detector layer 12 and the plurality of Read Out Integrated Chips 13 of circuit layer 14, connected together by means of solder bumps 18. As can be seen in FIG. 3B, the semiconductor pixel detectors comprise a plurality of semi-conductor wafer chips 20 which are tiled together, each semi-conductor wafer chip containing a plurality of pixels each of which is an x-ray photon counter. The wafers 20 are tiled together and placed on top of pixel read out cells 13 to which they are connected by solder bumps 18. The read out cells are connected by ultrasonic bonds 19 to the data acquisition and control circuit 16. The semiconductor pixel detectors chips are formed of a high quality epitaxial semiconductor material as this provides better signal to noise ratio and energy resolution, in particular by reducing the dark current noise of the pixel sensors caused by crystal defects and impurities found in industry standard semiconductor materials.

FIG. 4 shows the cross-sectional structure of a single semiconductor pixel detector cell. Pixel detector cell 22 comprises a layer of metal 24 which acts as an ohmic contact and is approximately 1 μm thick and effectively transparent to incident x-rays and a layer of high resistivity semiconductor, eg., Si or GaAs, 23 which is the semiconductor pixel detector material. Electrode 25 is a rectifying electrical contact embedded in pixel 22 and is connected by a solder bump 18 to one pixel read out circuit 14 which forms one element of a plurality of such circuits in a Read Out Integrated Circuit. The pixel ROIC 14 is ultrasonically bonded to control and data acquisition circuit 16. An electric field is applied across the pixel 22 by circuit 26 The pixel read out circuit 14 of each pixel detector cell 22 is connected by way of control lines connected to the control and acquisition circuit 16.

When an x-ray is incident upon the semiconductor detector pixel 12 each x-ray photon is detected by a pixel 22. The x-ray photon absorption leads to the generation of electron-hole pairs in the semiconductor. The number of pairs generated is representative of the energy of the x-ray. The electric signal on electrode 25, due to motion of the electron hole pairs in each pixel 22 in the electric field generated by circuit 26, is transferred via the solder bumps to the read out circuit. By analysing the magnitude of the electric signal which is proportional to the number of electron-hole pairs and thereby proportional to the absorbed x-ray energy, the read out circuit can provide a reading representative of the x-ray energy and the position of the absorbed x-ray photon. Each read out circuit contains a-data buffer which registers the number of absorbed x-rays satisfying prescribed energy requirements, the latter being representative of the density of the subject which was irradiated. The collection of pixel data from the read out cell 14 of each pixel is carried out simultaneously by means of pulsed signals and the collected data are transferred along control lines to buffer 16 from where they can be retrieved and reconstructed to form an image. The image quality obtained can be enhanced by the electric signal pulse height analysis x-ray energy discrimination as described above.

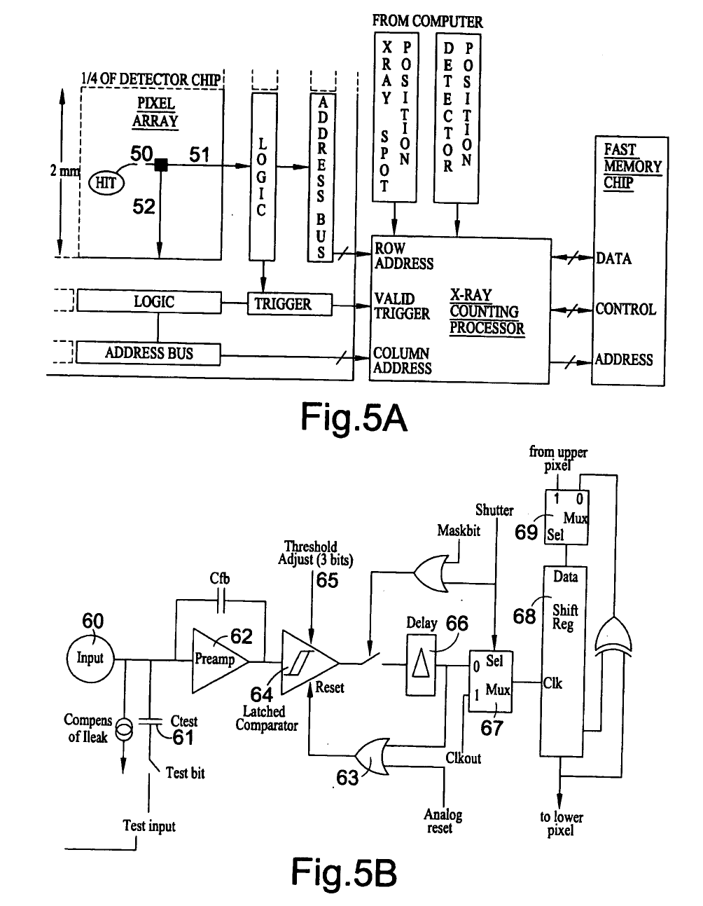

FIGS. 5A and 5B show an example arrangement of how the systematic read out of a pixel array detector can be achieved using row and column addressing to identify each pixel. The pixel 50 detects the absorption of an x-ray and thus generates and processes an electrical signal which it adds to the row bus 51 and column bus 52 passing its location.

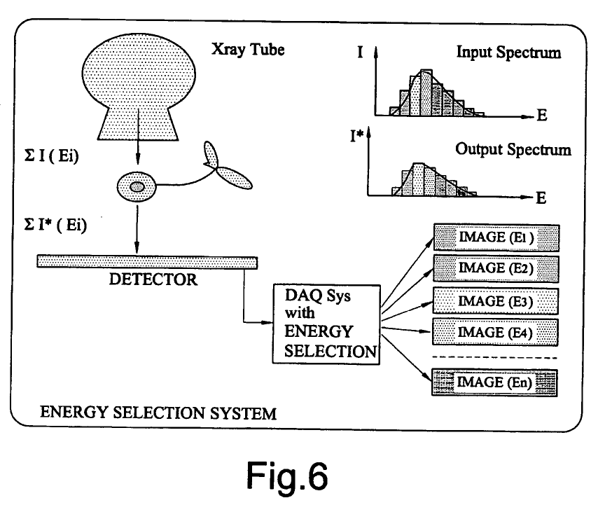

The processing of the electric signal within the chip is carried out by the pixel electronics such as those shown in FIG. 5B which are capable of processing a flux of x-rays typically not exceeding one million per pixel per second. The input 60 receives the electrical signal generated in the semiconductor pixel detector by the absorption of an x-ray photon. The input signal is fed through preamp 62 which amplifies the input signal to a level suitable for processing, the amplified signal is then fed to latched comparator 64. If the amplified signal energy level is below the designated threshold level of the latched comparator 64, a binary signal 0 is transferred on through the circuit. A binary signal 1 signifies that the signal energy level is above the designated threshold level. This binary signal then goes on to be stored in shift register 68 which acts as a binary counter. The shift register reading is taken sequentially with those from shift registers of other pixels and this information is then used to generate an image. In order to obtain accurate images representative of the irradiated subject several latched comparators 64 can be connected in parallel, each with a different threshold level. This would allow a number of absorbed x-rays in each of a range of energy intervals to be simultaneously recorded and considered in determining by image processing the most suitable energy range for providing the most useful image of the subject being irradiated. As image contrast depends on relative absorption power of the different tissues, which depends in turn on the x-ray energy, energy selection allows optimisation of contrast for given tissues. A schematic representation of the energy selection system is shown in FIG. 6.

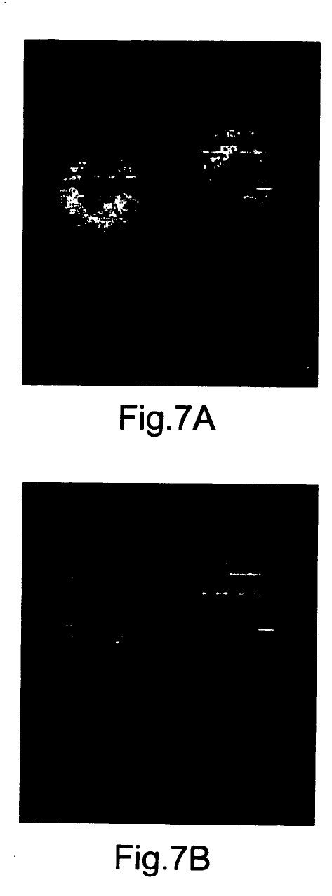

By using the energy selection principle it can be identified whether lower spectrum or higher spectrum energy is required to give the clearest image. Results from the changing of the energy range used for image formation are shown in FIGS. 7A and 7B as an example of the different contrast which is obtained at different energies. The image of the subject, which was two cherries, in 7A was obtained by imaging the cherries using x-rays in the energy range of 25-60 keV and the image of the cherries in 7B was obtained by imaging using an energy range of 25-35 keV. It can be seen from these images that the result of the energy selection changes the contrast of soft to hard tissues, in this case the lower energy spectrum being most suitable.

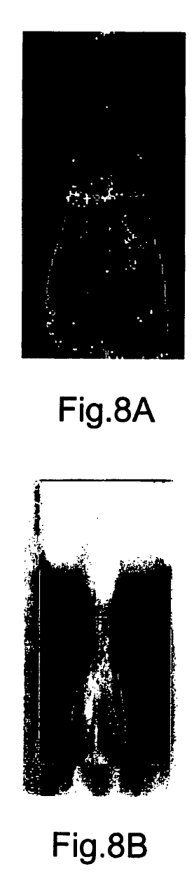

Another advantage of the present invention is that by using the x-ray detector plate of the present invention only one irradiation of the subject is required in order to obtain an image, thus speeding up the x-ray process. An additional advantage of this is the lowering of the dose required to provide a clear image. The combination of a single dose x-ray, the use of a compound semiconductor such as GaAs and the energy selection principle means in general a factor of twenty times lower dose, than that used in known x-ray detectors. For example, as shown in FIGS. 8A and 8B, using the present invention a dose of ˜35 μgy is required to give image 8A of a child's tooth. FIG. 8B was achieved using a commercial scintillator coated CCD system (Sens-A-Ray) using a dose of ˜980 μgy. The exact dose required is found by using the energy selection principle to identify the number of x-rays falling within each energy range so that contrast can be optimised.

Yet another advantage is that the requirement for the use of contrast fluid is reduced if not removed entirely. Typically current x-ray procedures require 300-400 mg/ml of contrast media, however, the use of the detector plate 10 can remove the need for the use of any contrast fluid. A suitable energy selection can, alone, often provide efficient contrast.

The imaging system, by using the x-ray detector of the present invention can also provide visual analysis, in real time, of the subject. This can be achieved using a pulsed x-ray generator or by irradiating the subject continuously. The read out of the detector is required to provide an inter image interval of less than one second and resolution must be at least 31 p/mm in order to satisfy cardiologist requirements for visual analysis.

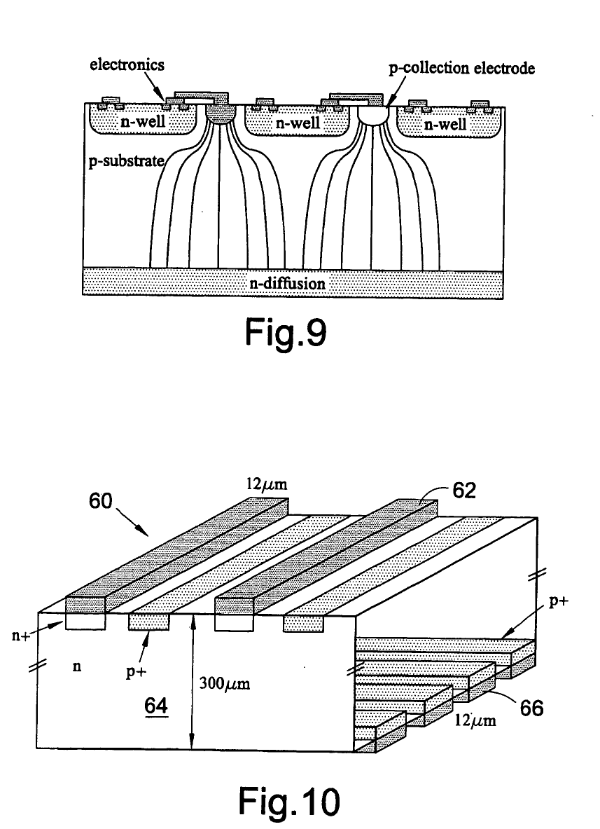

FIG. 9 shows the schematic structure of an alternative monolithic pixel structure which can be used as the pixel detector in the arrangement. It can be seen that the electric signal generated by the photon travels towards the electrode, in this case a p-collection electrode, embedded in the detector. The electrical signal generated is then processed within the electronics to provide energy selection information of the x-ray. The advantage of this system is that the processing of the electrical signal is carried out within the pixel detector. Although, at present, this arrangement is only possible using silicon as the semiconductor pixel detector, there are prospects of applying similar principles to Gallium Arsenide.

In FIG. 10 an alternative arrangement to the pixel detector arrangement is shown. The detector arrangement 60 has a plurality of aluminium electrodes 62 formed as strips on top of the semiconductor substrate 64. A plurality of reversed bias p-n junction electrodes 66 are formed as strips on the bottom of the semiconductor substrate and run perpendicularly to those formed on the top. When an x-ray photon is incident on the detector it is detected in an upper electrode 62 and also in a lower electrode 66. An electrical signal is created at the intersection point of the upper and lower electrode and this is indicative of the position of the incident photon. The energy of the photon is, as before, also detected. From these signals an image of the irradiated subject can be reconstructed.

The imaging system is particularly suited to perform angiography in humans or animals because of the use of a photon counting detector which. uniquely offers the possibility of digital x-ray imaging with simultaneous multiple images within a selectable limited range of x-ray energies. Such energy selection enables enhanced contrast resolution for all tissue types via such energy selection. and the opportunity thereby to avoid the double radiation dose of digital subtraction techniques and in most cases removing the need for contrast fluid. The imaging system is also particularly suited to angiography as it operates efficiently at energy ranges above 50 keV, again allowing the radiation dose required to be reduced, since known systems have low efficiency in this range of energy.

Various modifications can be made to the detector without departing from the scope of the invention. For example, the electric circuit 14 may alternatively be an existing commercial very large scale integrated chip, or a custom ASIC. The semiconductor detector material may be silicon, or it may be a group III-V semiconductor material such as GaAs, alternatively it could be Cadmium Telluride, CdZnTe, etc. Less aggressive contrast fluids currently being investigated, such as those based on CO₂, may be used. Those less toxic contrast fluids, presently less used because they provide poorer resolution in current systems than those based on iodine, can be used more effectively with the present system.

1. A medical imaging device comprising an x-ray detector having:
a plurality of semiconductor detector elements
wherein, in use, x-rays incident upon a semiconductor detector element, are directly converted into a corresponding electrical signal.

2. A medical imaging device, as claimed in claim 1 wherein the semiconductor detector elements are pixel detectors.

3. A medical imaging device, as claimed in claim 2, wherein the electrical signal from each pixel detector is fed to at least one electrical circuit whereupon the signal is digitised.

4. A medical imaging device, as claimed in any preceding claim, wherein the number of x-rays, within a selected energy range, absorbed by each pixel detector is recorded by a counter embedded in each pixel.

5. A medical imaging device, as claimed in any preceding claim, wherein the device is effective for detecting x-rays having an energy above 1 keV.

6. A medical imaging device, as claimed in any preceding claim, wherein the device is effective for detecting x-rays having energy in the range of 1 keV to 200 keV and in particular above 50 keV.

7. A medical imaging device, as claimed in any preceding claim, wherein the electrical signals represent the energy and incidence position of the absorbed x-rays.

8. A medical imaging device, as claimed in any preceding claim, wherein the semiconductor pixel detectors comprise a plurality of semiconductor wafer chips, each disposed on an electric circuit chip, tiled together.

9. A medical imaging device, as claimed in claim 8, wherein an electrical contact is made os a back side of each semiconductor wafer and a rectifying contact is made by an electrode embedded in each semiconductor pixel.

10. A medical imaging device, as claimed in claim 9, wherein each pixel electrode is connected to a corresponding electric signal digitising circuit.

11. A medical imaging device, as claimed in claim 10, wherein each electric circuit is a single Read Out Integrated Circuit.

12. A medical imaging device, as claimed in any preceding claim, wherein the pixel detectors are made from a compound semiconductor material such as a group III-V semiconductor material.

13. A medical imaging device, as claimed in any preceding claim, wherein the semiconductor material comprises a Gallium Arsenide based material

14. A medical imaging device, as claimed in any preceding claim, wherein the semiconductor is formed from epitaxially formed Gallium Arsenide or alloys thereof formed on a Gallium arsenide substrate.

15. A medical imaging device, as claimed in claim 14, wherein enhanced image quality is obtained by incorporating pulse height analysis on the electric signal processing of each pixel of the read only integrated circuit to permit counting via energy selection, of only the most appropriate energies of the absorbed x-rays for optimising image quality.

16. A medical imaging device, as claimed in claim 2, wherein each pixel detector is a monolithic semiconductor pixel detector wherein incident x-rays are directly converted into a corresponding electrical signal.

17. A medical imaging device, as claimed in claim 16, wherein the electrical signal is digitised and processed in electronics embedded within the monolithic semiconductor pixel detector.

18. A medical imaging device, as claimed in claim 1, wherein the semiconductor detector elements comprise a semiconductor substrate on one surface of which is disposed a plurality of electrodes formed of strips, and on an opposing surface of which is disposed a plurality of revers bias p-n junction electrodes formed as strips and running perpendicularly to those formed on top of the substrate, wherein each x-ray photon incident upon the detector creates an electrical signal at an intersection point of the electrodes on the opposing surfaces representative of the position thereof, and the energy of the photon.

19. A medical imaging apparatus including a medical imaging device as claimed in any of claims 1 to 18.

20. A medical imaging apparatus, as claimed in claim 19, wherein an x-ray generator generates the x-rays incident upon the semiconductor detector means.

21. A medical imaging apparatus, as claimed in claim 20 wherein a subject is disposed between the x-ray generator means and the semiconductor pixel means and the electrical signals generated in the semiconductor detector means is representative of the subject which has been irradiated.

22. A method of x-ray imaging a subject comprising the steps of:
disposing at least a part of the subject between an x-ray generator and a detector means;
irradiating the at least part of the subject with x-rays generated by the x-ray generator; and
directly converting the x-rays received by the detector means to an electrical charge, the conversion being performed by semiconductor pixels with the detector.

23. A method of x-ray imaging, as claimed in claim 22, further comprising the steps of;
transferring the electric charge, created by the absorbed x-ray energy to an electrode embedded in the respective pixel of a Read-Out Integrated Circuit (ROIC) by means of an electric field; and
converting the electric charge into an electrical signal.

24. A method of x-ray imaging, as claimed in claim 23, further comprising the steps of:
collecting the electrical charge form the pixels;
digitising the electric charge;
storing the digitised electric charge as data in a buffer within the ROIC pixel;
manipulating the stored data to provide an image representative of the x-rayed subject.

25. A method x-ray imaging, as claimed in claim 24, further comprising the steps of:
collecting the electrical signal at each electrode in a rows of pixels; and
transferring the electrical signal via the electric circuit to a read cut cell at the end of the row.

26. A method of x-ray imaging, as claimed in claim 25, further comrpising the steps of:
collecting pixel data from the read out cell of each row simultaneously and transferring the collected data to a buffer.

27. A method of x-ray imaging, as claimed in claim 26 further comprising the steps of:
transferring the digitised signals from the system to the video and recording systems for visual analysis.

28. A method of x-ray imaging, as claimed in claim 27, further comprising the steps of performing visual analysis in real time.

29. Use of a medical imaging device for performing x-ray imaging of a subject, the device comprising a plurality of semiconductor detector elements and at least one electric circuit, whereupon a flux of x-rays which have irradiated the subject are incident upon the semiconductor elements and are converted into corresponding electrical signals.

30. Use of a medical imaging device, as claimed in claim 29, wherein the electrical signals are indicative of the number and energy of individual respective photons.

31. Use of a medical imaging device, as claimed in claim 30, wherein the electrical signals are fed to at least one electric circuit whereupon the signals are digitised.

32. Use of a medical imaging device, as claimed in claim 31, wherein an image of the subject is reconstructed by at least one of the electric circuits form the electrical signals.

33. Use of a medical imaging device, as claimed in claim 29, wherein only one irradiation of the subject is required in order to obtain an image of the subject.

34. Use of a medical imaging device, as claimed in any of claims 29 to 33, wherein the device is for use performing angiography on humans and animals.
